(19) United States
(12) Patent Application Publication
(10) Pub. No.: US 2007/0278371 A1
(43) Pub. Date: Dec. 6, 2007

(54) Holder

(76) Inventor: Ching-Yang Wang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/443,076

(22) Filed: May 31, 2006

(51) Int. Cl. F16B 47/00

(52) U.S. Cl. 248/309.3

(57) ABSTRACT

The present invention is to provide a holding device comprising a support for mounting a portable electronic device thereon, a buffer and a base. One end of the buffer is pivotably connected to the support and the other end thereof is pivotably connected to the base. The support is adapted to pivot about one end of the buffer. The buffer is adapted to pivot about a top of the base. The base has a bottom fixed to a flat surface. By utilizing this holding device, the force of shocks and jarring can be absorbed by the buffer.

### FIELD OF THE INVENTION

The present invention relates to hands-free devices fixed to the interior of a motor vehicle, and more particularly to an improved device, fixed to the interior (e.g., dashboard) of an automobile, for holding a portable communications device (e.g., mobile phone) or a pocket-sized personal computer (e.g., PDA (Personal Digital Assistant)).

### BACKGROUND OF THE INVENTION

Technology has known a rapid, spectacular development in recent several decades. A variety of advanced electronic products are widely used by people. As a result, a lot of convenience is brought to our daily life and our living quality is improved significantly. Further, the fast development of such novel electronic products is closely associated with our daily life. Typical examples of the products are PDAs (Personal Digital Assistants) and mobile phones. These products are characterized in that they are portable, compact, and lightweight. Further, they are featured with memorandum, calendar, database, video game, phone book, dictionary, graphics, calculator, etc. As such, these portable electronic products are very popular among consumers. In response, more and more manufacturers of the art spend a lot of money and time in research and development of the portable electronic products. Hopefully, they can produce many types of portable electronic products with features such as being more powerful, compact, slim, and lightweight.

Applications of these portable electronic devices include, but not limited to, personal information management tool, video game machine, music player, and automobile navigation assistant. Typically, for ease of visual observation a holder is fixed to the interior (e.g., dashboard) of an automobile and a portable electronic device of the type described above is placed on or in the holder such that a driver may easily, conveniently use the portable electronic device while driving.

A variety of holders for holding a portable electronic device in an interior of an automobile are commercially available. One such holder is shown in FIG. 1. The holder comprises a rectangular base 10, a circular swivel mount 12 provided on the base 10 and having top gear teeth, a bracket 13 horizontally rotatably provided on a top of the swivel mount 12, a link 14 having one end hingedly interconnected two opposite flanges of the bracket 13, and a seat 15 having its bottom end pivotably provided at the other end of the link 14. A portable electronic device (not shown) may be mounted on the seat 15 and the base 10 is fixed to a flat surface (e.g., dashboard) of an automobile. A driver may turn both the swivel mount 12 and the link 14 to adjust height and inclined angle of the electronic device. Also, the driver may turn both the swivel mount 12 and the seat 15 to adjust a horizontal angle of the electronic device relative to the base 10.

In view of the facts that an automobile may vibrate after starting, driving on a road of irregularity, or the like. In this condition, the seat 15 may vibrate. Also, a portable electronic device mounted on the seat 15 may vibrate. Such vibration may cause inconvenience to the use of the portable electronic device. Further, internal components of the electronic device may malfunction due to long time of vibration. Furthermore, external components (e.g., write pen, memory card, or the like) connected to the portable electronic device may loosen due to long time of vibration. In addition, display of the portable electronic device may vibrate continuously while driving. As a result, a driver may experience a great difficulty of seeing what is shown on the display. Thus, it is desirable to substantially eliminate the vibration of a portable electronic device mounted on a seat of a holder while driving in order to overcome the inadequacy of the prior art.

### SUMMARY OF THE INVENTION

After considerable research and experimentation, a holder for holding a portable electronic device in an interior of an automobile according to the present invention has been devised so as to overcome the above drawback of the prior art.

It is an object of the present invention to provide a holding device comprising a support for mounting a portable electronic device thereon, a buffer, and a base. One end of the buffer is pivotably connected to the support and the other end thereof is pivotably connected to the base. The support is adapted to pivot about one end of the buffer. The buffer is adapted to pivot about a top of the base. The base has a bottom fixed to a flat surface. By utilizing this holding device, the force of shocks and jarring can be absorbed by the buffer.

The above and other objects, features and advantages of the present invention will become apparent from the following detailed description taken with the accompanying drawings.

### BRIEF DESCRIPTION OF THE DRAWINGS

FIG. 1 is an exploded view of a conventional holder for holding a portable electronic device in an interior of an automobile;

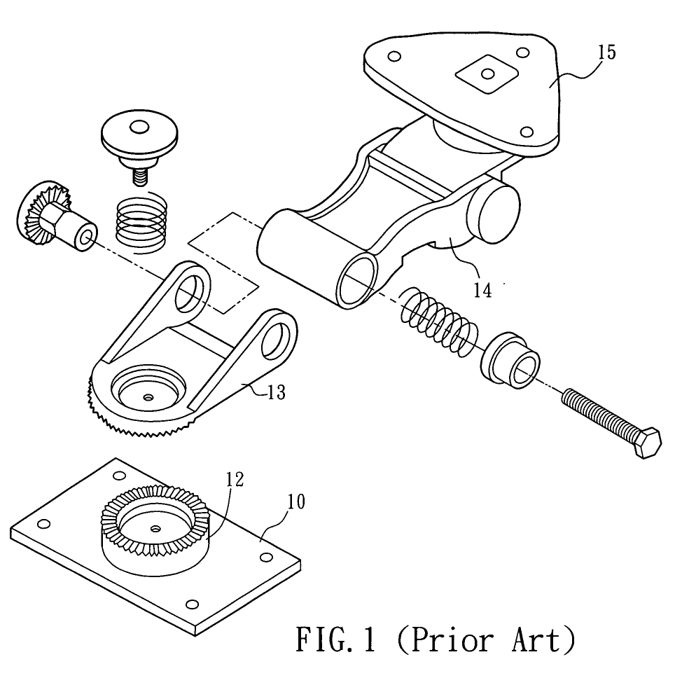

FIG. 2 is an exploded view of a first preferred embodiment of holder for holding a portable electronic device in an interior of an automobile according to the invention;

FIG. 3 is an exploded view of a second preferred embodiment of holder for holding a portable electronic device in an interior of an automobile according to the invention; and

FIG. 4 is an exploded view of a portion of a third preferred embodiment of holder for holding a portable electronic device in an interior of an automobile according to the invention.

### DETAILED DESCRIPTION OF THE PREFERRED EMBODIMENTS

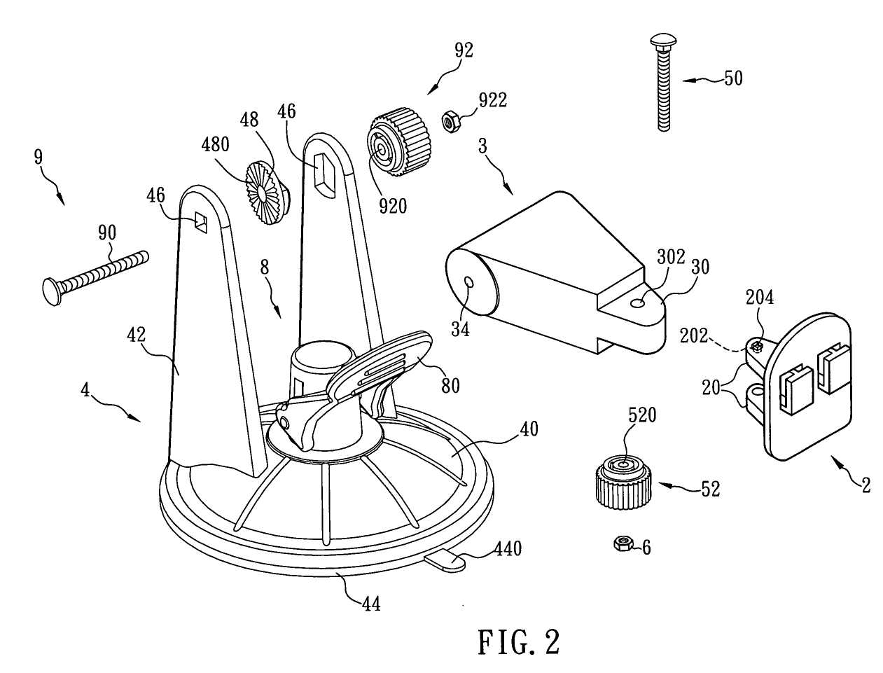

Referring to FIG. 2, a holder for holding a portable electronic device in an interior of an automobile in accordance with a first preferred embodiment of the invention is shown and comprises a support 2, a buffer 3, and a base 4. Each component is discussed in detailed below.

A top of the support 2 is formed with a seat (not shown). A portable electronic device (not shown) is adapted to mount on the seat. At least one first connection member (two are shown) 20 is extended from a bottom of the support 2. At least one second connection member 30 is formed at one end of the buffer 3. The second connection member 30 is adapted to snugly insert into a space between the two first connection members 20. Further, the first and second connection members 20 and 30 are adapted to pivotably fasten together. As such, the support 2 is adapted to pivot about one end of the buffer 3. The other end of the buffer 3 is pivotably connected to a top of the base 4. The base 4 has a bottom fixed to a flat surface (e.g., dashboard of an automobile). By configuring as above, a driver may adjust an angle of each of the support 2 and buffer 3 in order to obtain an optimum angle of a display of the portable electronic device relative to the driver for ease of operation. Also, the buffer 3 is adapted to absorb the force of shocks and jarring. As an end, probability of malfunction of internal components of the portable electronic device is greatly reduced. Further, external components (e.g., write pen, memory card, or the like) connected to the portable electronic device are not prone to loosening. Furthermore, the display of the portable electronic device is not subject to vibration. As a result, a driver can clearly see what is shown on the display.

Referring to FIG. 2, in the first preferred embodiment of the invention each of the first connection members 20 comprises a first through hole 202. One first connection member 20 further comprises a rectangular recess 204 formed at a mouth of the first through hole 202 on its outer surface. The second connection member 30 comprises a second through hole 302. A pivot unit 5 is adapted to pivotably connect the first connection members 20 and the second connection member 30 together. Thus, the support 2 is adapted to pivot about the buffer 3 on the pivot unit 5. The pivot unit 5 comprises a first threaded pin 50 and a first knob 52. The first knob 52 comprises a third through hole 520. A nut 6 is provided in the third through hole 520. The first pin 50 is adapted to drive through the second through hole 302 and the first through holes 202 into the third through hole 520. The head of the first pin 50 is received in and secured to the recess 204 of one first connection member 20 and the open end of the first pin 50 is inserted into the third through hole 520 to threadedly secure to the nut 6. Thus, turning the first knob 52 will adjust a position of the nut 6 relative to the first pin 50. As an end, the second connection member 30 is tightly clamped between the first connection members 20 and the first connection members 20 are thus fixed, or the second connection member 30 is loosely engaged between the first connection members 20 and the first connection members 20 are thus pivotal

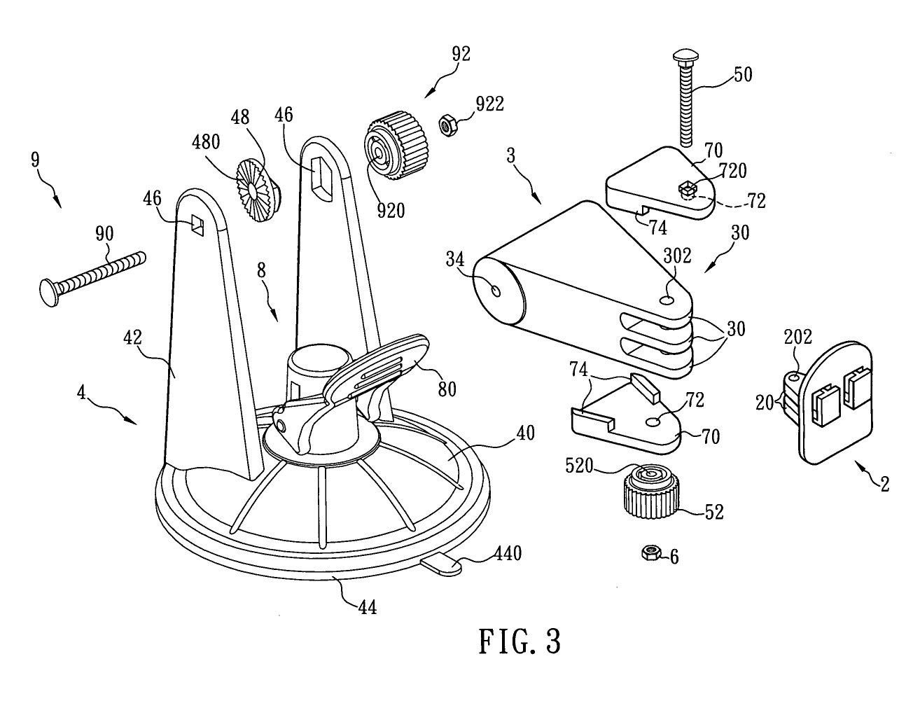

Referring to FIG. 3, a holder according to a second preferred embodiment of the invention is shown. The holder comprises a support 2, a buffer 3, a base 4, and a rigid clamp unit 7. Each component is discussed in detailed below.

A top of the support 2 is formed with a seat (not shown). A portable electronic device (not shown) is adapted to mount on the seat. A bottom of the support 2 is pivotably connected to one end of the buffer 3. As such, the support 2 is adapted to pivot about one end of the buffer 3. The other end of the buffer 3 is pivotably connected to a top of the base 4. The base 4 has a bottom fixed to a flat surface (e.g., dashboard of an automobile). The pivotal joining portion of the buffer 3 and the support 2 is clamped by the clamp unit 7. By configuring as above, a driver may adjust an angle of each of the support 2 and buffer 3 in order to obtain an optimum angle of a display of the portable electronic device relative to the driver for ease of operation. Also, the buffer 3 is adapted to absorb the force of shocks and jarring. As an end, probability of malfunction of internal components of the portable electronic device is greatly reduced. Further, external components (e.g., write pen, memory card, or the like) connected to the portable electronic device are not prone to loosening. Furthermore, the display of the portable electronic device is not subject to vibration. As a result, a driver can clearly see what is shown on the display. Note that the provision of the clamp unit 7 can increase the structural strength of the buffer 3.

Referring to FIG. 3, in the second preferred embodiment of the invention a pivot unit 5 is adapted to pivotably connect the support 2 and the buffer 3 together. Thus, the support 2 is adapted to pivot about the buffer 3 on the pivot unit 5. At least one first connection member (two are shown) 20 is extended from a bottom of the support 2. At least one second connection member (three are shown) 30 is formed at one end of the buffer 3 facing the bottom of the support 2. The first connection members 20 are adapted to snugly insert into two spaces each between two adjacent second connection members 30. As a result, the support 2 and the buffer 3 are pivotably fastened together.

In the second preferred embodiment the first connection member 20 comprises a first through hole 202 and the second connection member 30 comprises a second through hole 302. The pivot unit 5 comprises a first threaded pin 50 and a first knob 52. The first knob 52 comprises a third through hole 520. A nut 6 is provided in the third through hole 520. The clamp unit 7 comprises two triangular plates 70 each including a fourth through hole 72 adapted to permit the first pin 50 to insert. A rectangular recess 720 is formed at a mouth on an outer end of one fourth through hole 72. Thus, the first pin 50 is adapted to drive through the fourth through holes 72, the second through holes 302, and the first through holes 202 into the third through hole 520. The head of the first pin 50 is received in and secured to the recess 720. The open end of the first pin 50 is inserted into the third through hole 520 to threadedly secure to the nut 6. Thus, turning the first knob 52 will adjust a position of the nut 6 relative to the first pin 50. As an end, each of the first connection members 20 is tightly clamped between any two adjacent second connection members 30 and the second connection members 20 are thus fixed, or each of the first connection members 2 is loosely engaged between any two adjacent second connection members 30 and the second connection members 20 are thus pivotal.

In the second preferred embodiment each of the plate 70 further comprises two risers 74 formed along two edges terminated at the other end thereof. The risers 74 of each plate 70 are disposed facing either top or bottom of the buffer 3. The risers 74 of each plate 70 are adapted to fixedly attach to either top or bottom of the buffer 3 by clamping two top or bottom edges of the buffer 3. As a result, the plates 70 are held motionless when the nut 6 is threadedly secured to threaded shank of the first pin 50.

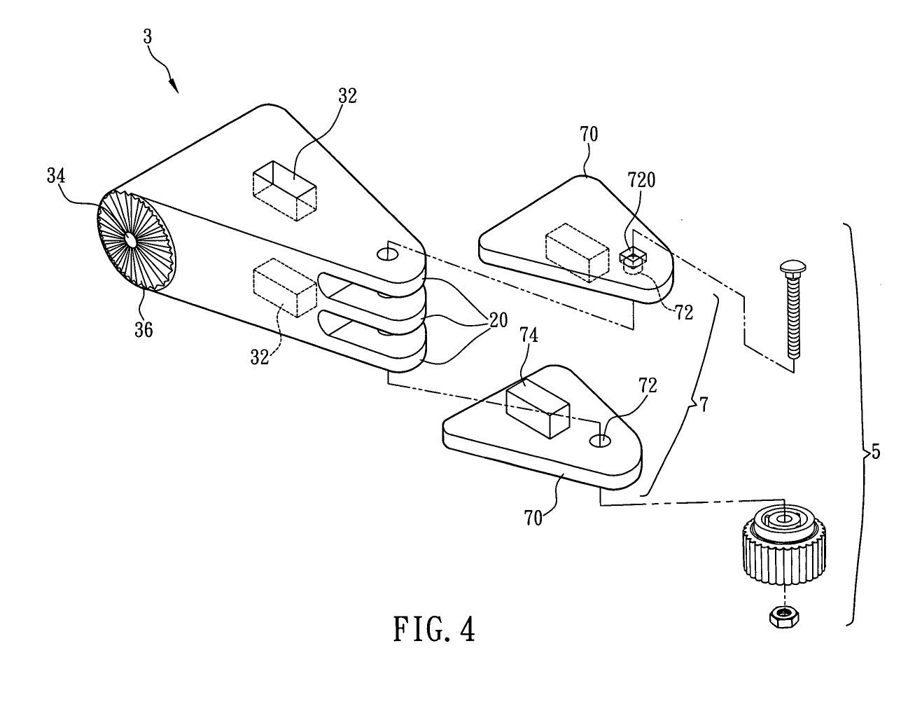

Referring to FIG. 4, a holder according to a third preferred embodiment of the invention is shown. A rectangular block 74 is formed on one face of either plate 70 facing top or bottom face of the buffer 3. Also, a rectangular slot 32 is formed on either top or bottom face of the buffer 3. The blocks 74 are adapted to snugly fit in the slots 32 for securing the plates 70 to the buffer 3. As a result, the plates 70 are held motionless when the nut 6 is threadedly secured to threaded shank of the first pin 50.

Referring to FIGS. 2 and 3 again, in each of the first and second preferred embodiments the base 4 comprises a disc-shaped plate member 40, two opposite arms 42, and a suction cup 44. The arms 42 are extended upright from top of the plate member 40. The suction cup 44 is formed on a bottom of the plate member 40 and has its circumferential edge projected from edge of the plate member 40. The suction cup 44 comprises a tab 440 projected from its edge. A trigger 8 is formed on a center of the plate member 40 and is extended through both top and bottom of the plate member 40. The trigger 8 is formed with a top of the suction cup 44. The portion of the trigger 8 projected from the plate member 40 is formed with a lever 80 facing the buffer 3. Pressing the lever 80 will pull a center of the suction cup 44 away from the plate member 40 toward the buffer 3 so as create a vacuum within the suction cup 44. As a result, the suction cup 44 is secured to the flat surface by the vacuum.

In each of the above preferred embodiments, top ends of the arms 42 are disposed facing the other end of the buffer 3 and are adapted to clamp the other end of the buffer 3. The buffer 3 comprises a fifth through hole 34 through its other end facing top of the base 4. Each of the arms 42 comprises an upper positioning hole 46 facing the other end of the buffer 3. A pivot unit 9 is provided through the fifth through hole 34 and the positioning holes 46. As an end, the other end of the buffer 3 is adapted to turn about an axis formed by the pivot unit 9 through the arms 42.

The pivot unit 9 comprises a second threaded pin 90 and a second knob 92. The second knob 92 comprises a sixth through hole 920. A nut 922 is provided in the sixth through hole 920. The second pin 90 is adapted to drive through the positioning holes 46 and the fifth through hole 34 into the sixth through hole 920. The head of the second pin 90 is received in and restricted by one positioning hole 46. The open end of the second pin 90 is extended beyond the other arm 42 into the sixth through hole 920 to threadedly secure to the nut 922. Thus, turning the second knob 92 will adjust a position of the nut 922 relative to the second pin 90. As an end, the other end of the buffer 3 facing top of the base 4 is tightly clamped between the arms 42 and is thus fixed, or the other end of the buffer 3 facing top of the base 4 is loosely engaged between the arms 42 and is thus pivotal. As a result, the other end of the buffer 3 is adapted to turn about an axis formed by the pivot unit 9 through the arms 42.

In each of the above preferred embodiments a disc-shaped limiting member 48 is formed at the other arm 42 facing the other end of the buffer 3. The limiting member 48 comprises a first toothed wheel 480 at one surface facing the other end of the buffer 3. A second toothed wheel 36 is formed on the other lateral face at the other end of the buffer 3 and is disposed facing the first toothed wheel 480. The first and second toothed wheels 480 and 36 are meshed together when the other end of the buffer 3 is clamped by and between the arms 42 extended from the top of the base 4. As a result, a rotation of the buffer 3 is made stepwise (i.e., each step representing a tooth rotation).

By configuring as above, the buffer 3 is adapted to absorb the force of shocks and jarring while driving. As such, drawback associated by the well known holder is eliminated. Further, the holder is adapted to adjust its angle. In the invention, the buffer 3 is formed of plastic or silicon rubber capable of buffering and absorbing the force of shocks and jarring. However, the buffer 3 is not limited to be formed of plastic or silicon rubber as described above. To the contrary, the buffer 3 can be formed of any suitable elastomeric materials.

While the invention herein disclosed has been described by means of specific embodiments, numerous modifications and variations could be made thereto by those skilled in the art without departing from the scope and spirit of the invention set forth in the claims.

What is claimed is:

1. A holding device comprising:
a support including a seat from on its top, the seat adapted to mount a portable electronic device thereon, and one or more first connection members extended from its bottom;
a buffer including at least one second connection member formed at one end, the second connection member adapted to insert into a space between the first connection members such that the first and second connection members are adapted to pivotably fasten together; and
a base having a top pivotably connected to the other end of the buffer and a bottom fixed to a flat surface.

2. The holding device of claim 1, further comprising a pivot unit adapted to pivotably connect the first connection members and the second connection member together such that the support is adapted to pivot about the buffer on the pivot unit.

3. The holding device of claim 2, wherein
each of the first connection members comprises a first through hole and a recess formed at a mouth of the first through hole on its outer surface;
the second connection member comprises a second through hole; and the pivot unit comprises:
a first knob including a third through hole and a first nut provided in the third through hole; and
a threaded first pin having a head secured to the recess and an open end driven through the second through hole and the first through holes into the third through hole to threadedly secure to the first nut.

4. The holding device of claim 3, wherein the base comprises:
a plate member;
two opposite arms extended upright from a top of the plate member for pivotably clamping the other end of the buffer between tops thereof;
a suction cup formed on a bottom of the plate member and having an edge projected from an edge of the plate member, the suction cup including a tab projected from its edge; and
a trigger formed on a center of the plate member and extended through both the top and the bottom of the plate member to be integral with a top of the suction cup, the trigger including a lever disposed externally of the plate member to face the buffer such that pressing the lever will pull a center of the suction cup away from the plate member toward the buffer.

5. The holding device of claim 4, wherein the tops of the arms are adapted to pivotably clamp the other end of the buffer therebetween;
the buffer further comprises a fifth through hole through its other end facing the top of the base; and
each of the arms comprises an upper positioning hole facing the other end of the buffer;
the holding device further comprising:
a pivot unit provided through the fifth through hole and the positioning holes such that the other end of the buffer is adapted to turn about an axis formed by the pivot unit through the arms, the pivot unit including:
a threaded second pin and a second knob including a sixth through hole and a second nut provided in the sixth through hole wherein the second pin is adapted to drive through the positioning holes and the fifth through hole into the sixth through hole, and wherein the second pin has a head secured to one positioning hole and an open end extended beyond the other arm to threadedly secure to the second nut.

6. The holding device of claim 5, further comprising a disc-shaped positioning member formed at the other arm facing the other end of the buffer, the positioning member including a first toothed wheel at one surface facing the other end of the buffer; and a second toothed wheel formed on the other lateral face at the other end of the buffer and disposed facing the first toothed wheel wherein the first and second toothed wheels are meshed together when the other end of the buffer facing the top of the base is clamped by and between the arms.

7. A holding device comprising:
a support including a seat from on its top, the seat adapted to mount a portable electronic device thereon;
a buffer having one end pivotably connected to the support;
a base having a top pivotably connected to the other end of the buffer and a bottom fixed to a flat surface; and
a rigid clamp unit for clamping a pivotal joining portion of the buffer and the support.

8. The holding device of claim 7, wherein
the support further comprises one or more first connection members extended from its bottom; and
the buffer comprises one or more second connection members formed at one end facing the bottom of the support, each of the first connection members adapted to insert into a space between any two adjacent ones of the second connection members such that the first and second connection members are adapted to fasten together.

9. The holding device of claim 8, further comprising a pivot unit adapted to pivotably connect the clamp unit, the support, and the buffer together such that the support is adapted to pivot about the buffer on the pivot unit.

10. The holding device of claim 9, wherein
each of the first connection members comprises a first through hole;
the second connection member comprises a second through hole;
the clamp unit comprises two plates each including a fourth through hole and a recess formed at a mouth one an outer surface of one fourth through hole; and
the pivot unit comprises:
a first knob including a third through hole and a first nut provided in the third through hole; and
a threaded first pin having a head secured to the recess and an open end driven through the fourth through holes, the second through holes, and the first through holes to threadedly secure to the first nut.

11. The holding device of claim 10, wherein each of the plate further comprises two positioning risers formed along two edges and terminated at the other end thereof, the positioning risers of each plate disposed facing either a top or a bottom of the buffer and adapted to fixedly attach to either the top or the bottom of the buffer by clamping two edges on the top or the bottom of the buffer.

12. The holding device of claim 10, wherein each of the plate further comprises a positioning block formed on one face facing the top or the bottom of the buffer, and wherein the buffer further comprises a slot formed on either the top or the bottom of the buffer, the slots being dimensioned and shaped to receive the positioning blocks for securing the plates to the buffer.

13. The holding device of claim 12, wherein the base comprises:
a plate member;
two opposite arms extended upright from a top of the plate member for pivotably clamping the other end of the buffer between tops thereof;
a suction cup formed on a bottom of the plate member and having an edge projected from an edge of the plate member, the suction cup including a tab projected from its edge; and
a trigger formed on a center of the plate member and extended through both the top and the bottom of the plate member to be integral with a top of the suction cup, the trigger including a lever disposed externally of the plate member to face the buffer such that pressing the lever will pull a center of the suction cup away from the plate member toward the buffer.

14. The holding device of claim 13, wherein the tops of the arms are adapted to pivotably clamp the other end of the buffer therebetween;
the buffer further comprises a fifth through hole through its other end facing the top of the base; and
each of the arms comprises an upper positioning hole facing the other end of the buffer;
the holding device further comprising:
a pivot unit provided through the fifth through hole and the positioning holes such that the other end of the buffer is adapted to turn about an axis formed by the pivot unit through the arms, the pivot unit including:
a threaded second pin and a second knob including a sixth through hole and a second nut provided in the sixth through hole wherein the second pin is adapted to drive through the positioning holes and the fifth through hole into the sixth through hole, and wherein the second pin has a head secured to one positioning hole and an open end extended beyond the other arm to threadedly secure to the second nut.

15. The holding device of claim 14, further comprising a disc-shaped positioning member formed at the other arm facing the other end of the buffer, the positioning member including a first toothed wheel at one surface facing the other end of the buffer; and a second toothed wheel formed on the other lateral face at the other end of the buffer and disposed facing the first toothed wheel wherein the first and second toothed wheels are meshed together when the other end of the buffer facing the top of the base is clamped by and between the arms.
